(19) United States
(12) Patent Application Publication
(10) Pub. No.: US 2008/0285968 A1
(43) Pub. Date: Nov. 20, 2008

(54) Compact camera module package structure

(75) Inventors: Ching Sheng Chang, Taichung City (TW); Hsiung Yu Tsai, Houlong Township (TW)

Correspondence Address: TROXELL LAW OFFICE PLLC, SUITE 1404, 5205 LEESBURG PIKE, FALLS CHURCH, VA, 22041, US

(73) Assignee: PowerGate Optical Inc.

(21) Appl. No.: 11/798,499

(22) Filed: May 14, 2007

(51) Int. Cl. G03B 17/02

(52) U.S. Cl. 396/542

(57) ABSTRACT

The present invention discloses a compact camera module (CCM) package structure that allows a lens module to adjoin directly on the CCM module to prevent height error that occurs when CCM module is soldered to the substrate from affecting the imaging performance of chip module. The CCM package structure comprises a substrate, a sensor chip module and a lens module. The lens module can encase and cover the sensor chip module, and adjoin the periphery of a light transmitting plane of the sensor chip module through a concave step disposed in the lens module so that the lens module can synchronously maintain the same horizontal angle and height as the light-transmitting plane of sensor chip module, thereby reducing error occurred in the manufacturing process and allowing the lens module and the sensor chip module to produce better focusing and image quality.

### BACKGROUND OF INVENTION

1. Field of the Invention

The present invention relates to a package structure for compact camera module (CCM).

2. Description of the Prior Art

With the advent of technology, all kinds of portable electronic instruments and devices become available. Product components also evolve towards lightweight, thin, short, and small. How to make an electronic product user-friendlier, serve multiple functions, compact in size with ergonomic design to make carriage convenient and give consumers a sense of fashion are major topics in the consumer market nowadays. A few examples of significant breakthrough in technological development are mobile phone that comes with the function of a digital camera, or notebook or personal digital assistant (PDA) that also works as a digital camera.

All mobile phones on the market nowadays stress compactness. Camera-type mobile phones are particularly popular. Now mobile phone can incorporate 3G functions that allow video communication between caller and recipient via the Internet. Thus the trend of the future for mobile phone should be diversity and full functions, which might replace digital camera to become an all-purpose device that can take pictures, allow communication, and access the Internet.

FIG. 1 shows a sectional view of a conventional compact camera module (CCM) package structure. Conventional CCM package structure 1 comprises a substrate 10, a sensor chip module 11, a lens barrel 12, and a holder 13. The sensor chip module 11 further comprises an image sensor chip 111, a transparent cover plate 112 and a chip carrier 113.

The sensor chip module 11 is soldered to the substrate 10, and the hollow holder 13 encircles the sensor chip module 11 at one end and mounted on the substrate 10. The outer threads 121 of lens barrel 12 match the inner threads 131 disposed inside the other end of holder 13, and lens barrel 12 is configured with an aperture 122 at the top face. Behind the aperture 122 inside the lens barrel 12 are disposed in sequence a lens set 123 and a light-transmitting layer 124.

Errors occurred in the CCM manufacturing process are the primary factor that affects the image quality. Those errors include height (axial) error occurred when sensor chip module 11 and substrate 10 are electrically connected via solder balls, and height (axial) error occurred when the transparent cover plate 112 of sensor chip module 11 adjoins the chip carrier 113. The magnitude of those two errors is approximately ±0.05 mm and ±0.02 mm respectively. Thus the total magnitude of axial error of image focus could reach ±0.07 mm. Rotating the threaded lens barrel 12 within the holder 13 can adjust the axial distance between lens barrel 12 and sensor chip module 11 during focusing, thereby decreasing the magnitude of error and resulting in better image position. However, prior art demands more time and cost to adjust error to acceptable range, and lens barrel 12 and holder 13 must be separately fabricated with two sets of molds and then assembled, which jacks up the manufacturing and assembly costs.

### SUMMARY OF INVENTION

The primary object of the present invention is to provide a compact camera module (CCM) package structure, which utilizes a concave step configured at the open end of a lens module to adjoin the periphery of the light-transmitting plane of a sensor chip module so that the lens module can synchronously maintain the same horizontal angle and height as the light-transmitting plane of the chip module, thereby eliminating the height error of sensor chip module occurred when it is soldered to the substrate and letting the error stay within acceptable range.

Another object of the present invention is to provide a CCM package structure, where holder and lens barrel are formed as one piece into a lens module, thereby reducing the fabrication cost by using only one mold.

To achieve the aforesaid objects, the present invention provides a CCM package structure, comprising a substrate, a sensor chip module, and a lens module. The substrate is a printed circuit board having a first substrate and a second substrate surface. The sensor chip module has a light-transmitting plane and a connecting plane. The connecting plane of senor chip module is electrically connected to the first substrate surface through solder balls. The lens module contains a hollow barrel holder, which is disposed with a concave step at the inner edge of the open end, and an aperture at the other end face opposing the open end. In the accommodation space behind the aperture there disposes in sequence a lens and a light-transmitting layer.

The lens module can adjoin the periphery of the light-transmitting plane of the sensor chip module through the concave step inside the lens module, and at the same time, encase and cover the sensor chip module so that the lens module can maintain synchronously the same horizontal angle and height as the light-transmitting plane of sensor chip module, which further reduces the height error occurred in the process when sensor chip module is soldered to the substrate and keeps the error within acceptable range, and at the same time cuts production costs.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectional view of a conventional CCM package structure;

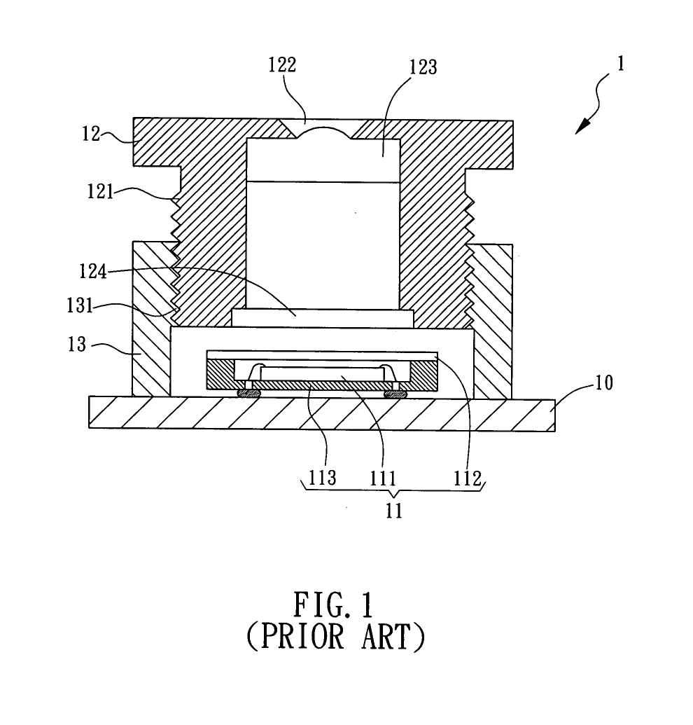

FIG. 2 is an exploded sectional view of a CCM lens package structure according to a first embodiment of the invention;

FIG. 3 is an assembled sectional view of a CCM lens package structure according to a first preferred embodiment of the invention;

FIG. 4 is an assembled sectional view of a CCM lens package structure according to a second preferred embodiment of the invention;

FIG. 5 is an assembled sectional view of a CCM lens package structure according to a third preferred embodiment of the invention;

FIG. 6 is an assembled sectional view of a CCM lens package structure according to a fourth preferred embodiment of the invention;

FIG. 7 is an assembled sectional view of a CCM lens package structure according to a fifth preferred embodiment of the invention.

### DETAILED DESCRIPTION

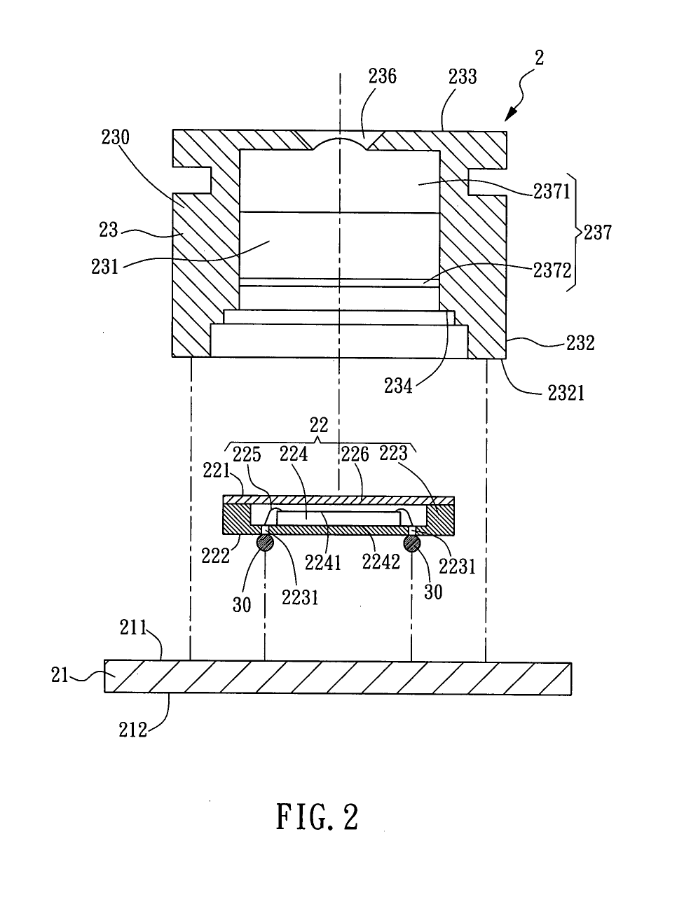

FIG. 2 is an exploded sectional view of a CCM lens package structure according to a first embodiment of the invention, in which, the CCM package structure 2 comprises mainly of a substrate 21, a sensor chip module 22, and a lens module 23.

Substrate 21 has a first substrate surface 211 and a second substrate surface 212. In general, substrate 21 is a printed circuit board and disposed with a plurality of circuits on the first substrate surface 211 and the second substrate surface 212. The sensor chip module 22 has a light-transmitting plane 221 and a connecting plane 222 to capture external images. The sensor chip module 22 further comprises a chip carrier 223, an image sensor chip 224, a plurality of metal wires 225, and a transparent cover plate 226. The image sensor chip 224 is typically a charge coupled device (CCD) or a complementary metal oxide semiconductor (CMOS), and has an acting side 2241 and a non-acting side 2242. The acting side 2241 is the side that is able to capture outside images. The image sensor chip 224 is bonded to the chip carrier 223 and electrically connected to the chip carrier 223 via a plurality of metal wires 225, and electrically connected to the connecting plane 222 via through-hole 2231. The transparent cover plate 226 sits on top of the image sensor chip 224 and couples to the chip carrier 223 to become an integrated sensor chip module 22.

The lens module 23 further comprises a hollow barrel holder 230, an accommodation space 231, an open end 232, a top face 233, a concave step 234, an aperture 236, and a lens group 237 composed of at least one lens. The hollow barrel holder 230 is a one-piece element made from injection molding, and forms a through accommodation space 231 inside. The concave step 234 is disposed at the inner edge of open end 232 of the hollow barrel holder 230 in lens module 23, and an aperture 236 is disposed at another top face 233 opposing the open end 232. The accommodation space is disposed with a lens group 237 inside. The lens group 237 further comprises a lens set 2371 and a light-transmitting layer 2372, which are arranged in sequence behind the aperture 236 inside the accommodation space 231. The light-transmitting layer 2372 may be an infrared filter lens.

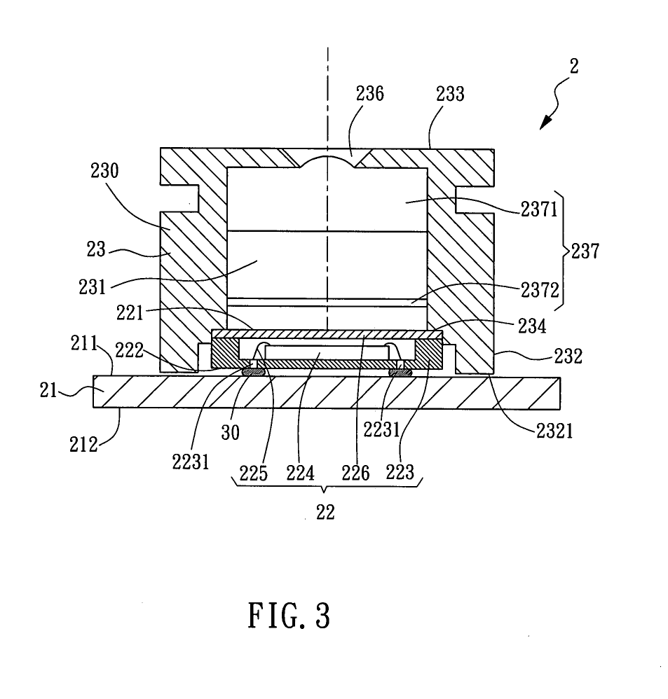

FIG. 3 is an assembled section view of a CCM package structure according to a first preferred embodiment of the invention, in which, the connecting plane 222 of sensor chip module 22 is mounted on the first substrate surface 211 of substrate 21 through a plurality of solder balls 30, and sensor chip module 22 is electrically connected to substrate 21. The lens module 23 utilizes the concave step 234 disposed therein to adjoin the periphery of light-transmitting plane 221 by means of visual positioning, meanwhile the open end 232 of lens module 23 encases and covers the sensor chip module 22. At this time, an end face 2321 of open end 232 generally does not directly adjoin the first substrate 211, but has a small gap therebetween. Such arrangement allows lens module 23 to synchronously maintain the same axial height and horizontal angle as the light-transmitting plane 221 of sensor chip module 22, and renders the acting side 2241 of image sensor chip 224, the aperture 236 of the lens module 23, the lens set 2371, and the light-transmitting layer 2372 to be positioned on the same center axis to focus and capture images.

The adjoining of lens module 23 to the periphery of light-transmitting plane 221 of sensor chip module 22 through the concave step 234 disposed therein enables lens module 23 to be positioned at the same height and horizontal angle as the sensor chip module 22. Not only lens module 23 and sensor chip module 22 are kept on the same center axis, the height error created by solder balls 30 that bring about the electrical connection between sensor chip module 22 and substrate 21 will not affect the distance between the lens set 2371 in lens module 23 and the acting side 2241 of image sensor chip 224, thereby resulting in better image focus. As such, in the manufacturing process of CCM package structure 2, the focus error of approximately ±0.05 mm created by solder balls 30 is totally eliminated, thereby greatly reducing the focus error. In other words, in the CCM package structure 2, the relative axial distance between lens module 23 and sensor chip module 22 is totally unaffected regardless the magnitude of axial error created by solder balls 30 (that is, the axial height between lens set 2371 and the light-transmitting plane 221 of sensor chip module 22 is a constant value).

Therefore, the only variable that affects focusing performance in the process of sensor chip module 22 is approximately ±0.02 mm focus error that occurs when the transparent cover plate 226 adjoins the chip carrier 223. Such minute error within ±0.02 mm is a range commonly acceptable in the industry without requiring fine tuning of axial position of chip module 22 to correct the axial error created by solder balls 30. Thus in the CCM package structure 2 of the invention, the hollow barrel holder 230 of the lens module 23 is formed into one piece as a single element, instead of being separated into a lens barrel 12 and a holder 13 as in prior art in order to provide the function of fine tuning by threading. The lens module 23 in one piece only requires one mold for production and saves the assembly process of threading, thereby reducing the costs of mold and assembly. Moreover, lens module 23 which is suitable for batch production does not require readjustment to proper focal length.

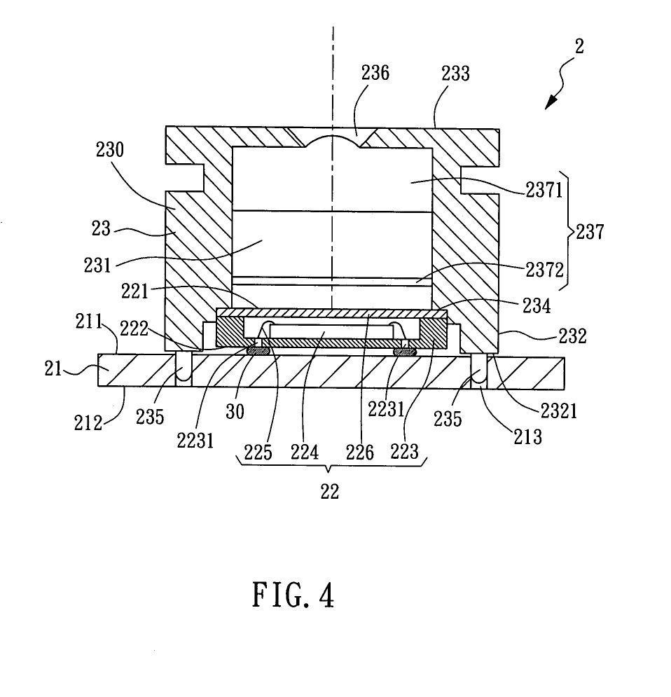

FIG. 4 is an assembled exploded view of a CCM package structure according to a second preferred embodiment of the invention, which is in general similar to the first preferred embodiment shown in FIG. 3. Thus identical components and structures will not be reiterated below. The difference is that the substrate 21 in second preferred embodiment is disposed with at least a positioning mortise hole 213, and the hollow barrel holder 230 is disposed with at least a positioning tenon 235 at the end face 2321 of its open end 232. The positioning tenon 235 can insert into the positioning mortise hole 213.

The positioning tenon 235 disposed on lens module 23 enables the lens module 23 to be positioned in the positioning mortise hole 213 of the substrate 21. In addition, because the positioning tenon 235 is not fixated in the positioning mortise hole 213, friction resistance at the contact surface between the inner edge of positioning mortise hole 213 and the surface of positioning tenon 235 can shoulder the some of the weight exerted by lens module 23 when it adjoins the senor chip module 22 through the concave step 234 and transfer the weight to the substrate 21 to protect the sensor chip module 22 from the crushing weight of lens module 23.

Meanwhile, the end face 2321 of lens module 23 typically does not directly adjoin the first substrate surface 211 of substrate 21, but leaving a small gap therebetween, which enables lens module 23 to adjoin the periphery of light-transmitting plane 221 of sensor chip module 22 through the concave step 234, and to maintain synchronously the same axial height and horizontal angle as the light-transmitting plane 221 of sensor chip module 22. Furthermore, it enables simultaneously the acting side 2241 of image sensor chip 224, the aperture 236 of lens module 23, the lens set 2371, and the light-transmitting layer 2372 to be positioned on the same center axis.

To sum up, in the CCM package structure of the invention, the lens module 21 can encase and cover the sensor chip module 22 and adjoin the periphery of light-transmitting plane 221 of sensor chip module 22 through the concave step 234 therein, so that lens module 21 can synchronously maintain the same horizontal angle and height as the light-transmitting plane 221 of sensor chip module 22. Such arrangement further eliminates height error occurred in the manufacturing process when sensor chip module 22 is soldered to the substrate 21 and allows process error to stay within the industry acceptable range, thereby achieving better image quality without focus adjustment.

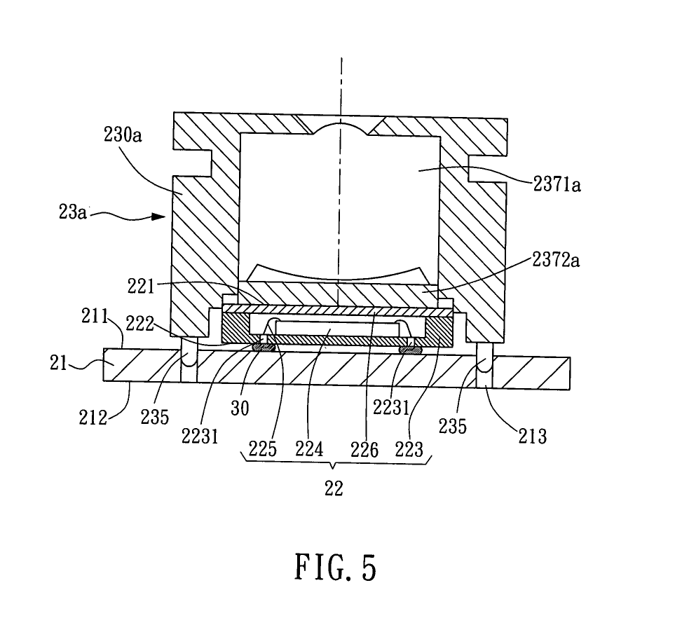

FIG. 5 is an assembled sectional view of a CCM lens package structure according to a third preferred embodiment of the invention, which is in general similar to the second preferred embodiment shown in FIG. 4. Thus identical components and structures will not be reiterated below. The lens module 23a of the third embodiment also includes a hollow barrel holder 230a, a lens set 2371a furnished inside the barrel holder 230a, and a light-transmitting layer 2372a located below and contacted with the bottom side of lens set 2371a. The light-transmitting layer 2372a may be an infrared filter lens. The difference between this third embodiment and the aforementioned second embodiment is that, the light-transmitting plane 221 located on the top side of transparent cover plate 226 is directly adjoining the bottom surface of the light-transmitting layer 2372a. Such that, the lens module 23a can synchronously maintain the same horizontal angle and height as the light-transmitting plane 221 of the chip module 22, thereby eliminating the height error of sensor chip module 22 occurred when it is soldered to the substrate 21 by solder balls 30 and letting the error stay within acceptable range.

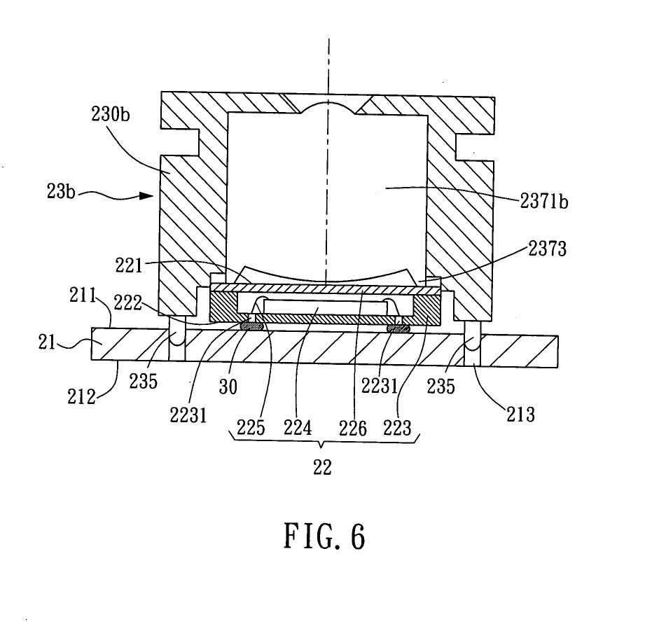

FIG. 6 is an assembled sectional view of a CCM lens package structure according to a fourth preferred embodiment of the invention, which is in general similar to the third preferred embodiment shown in FIG. 5. The lens module 23b of the fourth embodiment also includes a hollow barrel holder 230b and a lens set 2371b furnished inside the barrel holder 230b. The difference is that, the light-transmitting plane 221 located on the top side of transparent cover plate 226 is directly adjoining the bottom ends 2373 of the lens set 2371b.

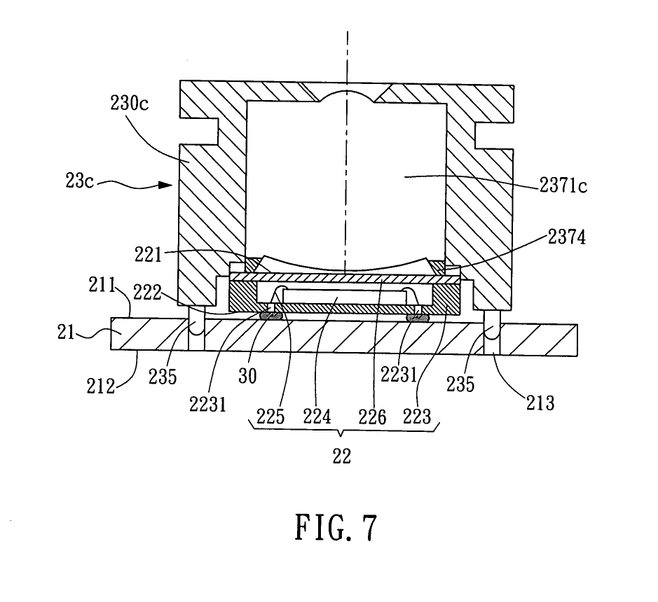

FIG. 7 is an assembled sectional view of a CCM lens package structure according to a fifth preferred embodiment of the invention, which is in general similar to the fourth preferred embodiment shown in FIG. 6. The lens module 23c of the fourth embodiment also includes a hollow barrel holder 230c and a lens set 2371c furnished inside the barrel holder 230c, and is further furnished with a lens retainer 2374 at the bottom side of the lens set 2371c. The difference is that, the light-transmitting plane 221 located on the top side of transparent cover plate 226 is directly adjoining the bottom ends of lens retainer 2374.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A compact camera module package structure, comprising:
a substrate having a first substrate surface and a second substrate surface and disposed with at least a circuit;
a sensor chip module having a light-transmitting plane and a connecting plane; the connecting plane being electrically connected to the first substrate surface through at least one solder ball; and
a lens module containing a hollow barrel holder with a through accommodation space formed therein; a concave step being disposed at the inner edge of an open end of the lens module and an aperture being disposed at the other top face opposing the open end; at least one lens being disposed inside the accommodation space;
wherein the lens module adjoins at least a part of light-transmitting plane of sensor chip module and encases the sensor chip module so that the lens module is able to synchronously maintain the same horizontal angle and height as the light transmitting plane of senor chip module, and to position on the same center axis as the light transmitting plane.

2. The package structure according to claim 1, wherein said light-transmitting plane directly adjoins the concave step of the lens module.

3. The package structure according to claim 1, wherein said lens module further comprises a lens retainer located at a bottom side of the lens; wherein said light-transmitting plane directly adjoins a bottom end of the lens retainer.

4. The package structure according to claim 1, wherein said lens module further comprises a light-transmitting layer located at a bottom side of the lens; wherein said light-transmitting plane directly adjoins a bottom surface of the light-transmitting layer.

5. The package structure according to claim 4, wherein said light-transmitting layer is an infrared filter lens.

6. The package structure according to claim 1, wherein said sensor chip module further contains:
a chip carrier being a concave-shaped frame and having a center accommodation area and at least a through hole;
an image sensor chip having an acting side and a non-acting side, and coupled to the center accommodation area of chip carrier through the non-acting side;
a plurality of metal wires able to electrically connect the image sensor chip and the through hole of chip carrier; and
a transparent cover plate which is laid over the image sensor chip and coupled to the chip carrier.

7. The package structure according to claim 1, wherein said substrate is disposed with at least a positioning mortise hole, and at least a positioning tenon at an end face of the open end of hollow barrel holder that can be inserted into the positioning mortise hole, and the end face does not directly adjoin the first substrate surface of substrate.

8. The package structure according to claim 1, wherein said hollow barrel holder is a single element formed in one piece, and an axial height between the lens and the light-transmitting plane is a constant value that is non-adjustable.

9. A compact camera module package structure, comprising:
a substrate having a first substrate surface;
a sensor chip module having a light-transmitting plane and coupled to the first substrate surface; and
a lens module having a hollow barrel holder and disposed with at least a lens therein; a concave step being disposed at the inner edge of an open end of the hollow barrel holder and an end face of the open end being not directly adjoined to the first substrate surface, while the concave step being adjoined to the periphery of light-transmitting plane.

10. The package structure according to claim 9, wherein said sensor chip module is coupled and electrically connected to the first substrate surface through a plurality of solder balls.

11. The package structure according to claim 9, wherein said sensor chip module further contains:
a chip carrier being a concave-shaped frame and having a center accommodation area and at least a through hole;
an image sensor chip having an acting side and a non-acting side, and coupled to the center accommodation area of chip carrier through the non-acting side;
a plurality of metal wires able to electrically connect the image sensor chip and the through hole of chip carrier; and
a transparent cover plate which is laid over the image sensor chip and coupled to the chip carrier.

12. The package structure according to claim 9, wherein said hollow barrel holder is a single element formed in one piece, and an axial height between the lens and the light-transmitting plane is a constant value that is non-adjustable.

13. The package structure according to claim 9, wherein said substrate is disposed with at least a positioning mortise hole, and at least a positioning tenon at an end face of the open end of hollow barrel holder that can be inserted into the positioning mortise hole, and the end face does not directly adjoin the first substrate surface of substrate.

14. A compact camera module package structure, comprising a substrate, a sensor chip module and a lens module, characterized in which:
said lens module comprises a hollow barrel holder and at least a lens disposed inside the hollow barrel holder; the hollow barrel holder is a single element formed in one piece; a concave step is disposed at the inner edge of an open end of the hollow barrel holder; wherein the open end does not directly adjoin the substrate, while the concave step enables the lens module to adjoin the sensor chip module, thereby providing the function of positioning the lens module and the sensor chip module.

15. The package structure according to claim 14, wherein said sensor chip module is coupled and electrically connected to the first substrate surface through a plurality of solder balls.

16. The package structure according to claim 14, wherein said sensor chip module further contains:
a chip carrier being a concave-shaped frame and having a center accommodation area and at least a through hole;
an image sensor chip having an acting side and a non-acting side, and coupled to the center accommodation area of chip carrier through the non-acting side;
a plurality of metal wires able to electrically connect the image sensor chip and the through hole of chip carrier; and
a transparent cover plate which is laid over the image sensor chip and coupled to the chip carrier.

17. The package structure according to claim 16, wherein said substrate is disposed with at least a positioning mortise hole, and the hollow barrel holder is disposed with at least a positioning tenon at an end face of its open end, which can be inserted into the positioning mortise hole.

18. The package structure according to claim 14, wherein said at least a lens further comprises a lens and a light-transmitting layer being arranged in sequence behind the aperture.

19. The package structure according to claim 18, wherein said light-transmitting layer is an infrared filter lens.

20. The package structure according to claim 14, wherein said hollow barrel holder is a single element formed in one piece, and an axial height between the lens and the light-transmitting plane is a constant value that is non-adjustable.
